(19) United States
(12) Patent Application Publication
(10) Pub. No.: US 2017/0284938 A1
(43) Pub. Date: Oct. 5, 2017

(54) BIOLOGICAL TISSUE OBSERVATION APPARATUS AND BIOLOGICAL TISSUE OBSERVATION METHOD

(71) Applicant: OLYMPUS CORPORATION, Tokyo (JP)

(72) Inventors: Shinichi TAKIMOTO, Tokyo (JP); Yohei TANIKAWA, Tokyo (JP)

(73) Assignee: OLYMPUS CORPORATION, Tokyo (JP)

(21) Appl. No.: 15/631,358

(22) Filed: Jun. 23, 2017

Related U.S. Application Data
(63) Continuation of application No. PCT/JP2014/084419, filed on Dec. 25, 2014.

(51) Int. Cl. G01N 21/64; G02B 21/18

(52) U.S. Cl. CPC G01N 21/64; G02B 21/18

(57) ABSTRACT

Provided is a biological tissue observation apparatus including an optical fiber probe that receives fluorescence via an input end disposed at one end thereof and that optically guides the fluorescence toward the base end in the longitudinal direction, a photodetector that is disposed facing an output end disposed at the base end of the optical fiber probe and that detects the fluorescence output from the output end, and a scatter suppressing unit provided near the input end of the optical fiber probe.

### CROSS-REFERENCE TO RELATED APPLICATIONS

This is a continuation of International Application PCT/JP2014/084419, with an international filing date of Dec. 25, 2014, which is hereby incorporated by reference herein in its entirety.

### TECHNICAL FIELD

The present invention relates to biological tissue observation apparatuses and biological tissue observation methods.

### BACKGROUND ART

When observing fluorescence from living biological tissue as an observation site by using a microscope, it is known that light scattering occurring in the biological tissue has an adverse effect on the fluorescence imaging result. Specifically, the fluorescence generated in the biological tissue is scattered due to light scattering occurring before the fluorescence reaches a fluorescence detector disposed outside the biological tissue. Thus, the fluorescence cannot be captured efficiently.

For example, when performing fluorescence imaging using living brain tissue as an observation site, the cranium covering the brain tissue acts as a scatterer, thus causing fluorescence generated in the brain tissue to be scattered by the cranium. As a result, the fluorescence cannot be efficiently captured by the fluorescence detector disposed outside the cranium.

A known method for reducing the effect of such light scattering is an observation method that involves physically removing the scatterer that eliminates the fluorescence (for example, see Patent Literature 1).

In order to eliminate the effect of light scattering at the cranium, this observation method involves forming an opening by physically resecting the cranium so as to expose the brain tissue serving as the observation site. By using the opening as an optical window, the fluorescence generated in the brain tissue can be captured efficiently.

### CITATION LIST

### Patent literature

### {PTL 1}

Japanese Unexamined Patent Application, Publication No. 2011-196852

### SUMMARY OF INVENTION

An aspect of the present invention provides a biological tissue observation apparatus including a photodetector that detects light and a scatter suppressing unit that is provided in the photodetector and that denatures biological tissue disposed facing the photodetector so as to make a refractive-index distribution in the biological tissue uniform.

Furthermore, another aspect of the present invention provides a biological tissue observation method including a rarefying step of denaturing biological tissue covering an observation site so as to make a refractive-index distribution in the biological tissue uniform and a detecting step of detecting light released outward from the observation site via the biological tissue denatured in the rarefying step.

### BRIEF DESCRIPTION OF DRAWINGS

FIG. 1 is a vertical sectional view illustrating a biological tissue observation apparatus according to an embodiment of the present invention.

FIG. 2 is a vertical sectional view illustrating an example of fluorescence observation using the biological tissue observation apparatus in FIG. 1.

FIG. 3 is a flowchart explaining a biological tissue observation method according to an embodiment of the present invention using the biological tissue observation apparatus in FIG. 1.

FIG. 4 is a vertical sectional view illustrating a modification of the biological tissue observation apparatus in FIG. 1.

### DESCRIPTION OF EMBODIMENTS

A biological tissue observation apparatus 1 and a biological tissue observation method according to an embodiment of the present invention will be described below with reference to the drawings.

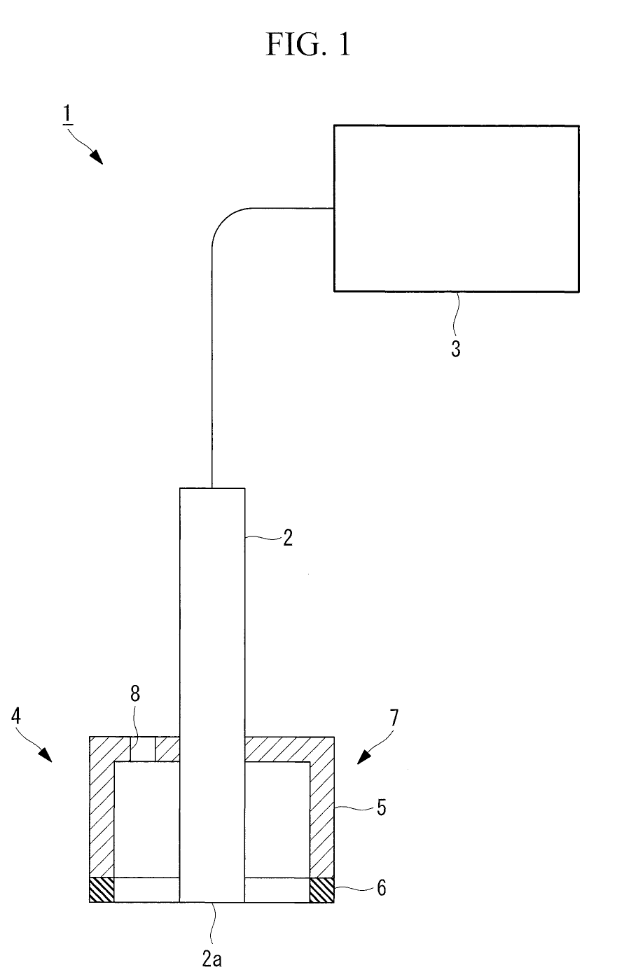

As shown in FIG. 1, the biological tissue observation apparatus 1 according to this embodiment is a fluorescence observation apparatus and includes an optical fiber probe (photodetector) 2 that receives fluorescence via an input end 2a disposed at one end thereof and that optically guides the fluorescence toward the base end in the longitudinal direction, a photodetector 3 that is disposed facing an output end disposed at the base end of the optical fiber probe 2 and that detects the fluorescence output from the output end, and a scatter suppressing unit 4 provided near the input end 2a of the optical fiber probe 2.

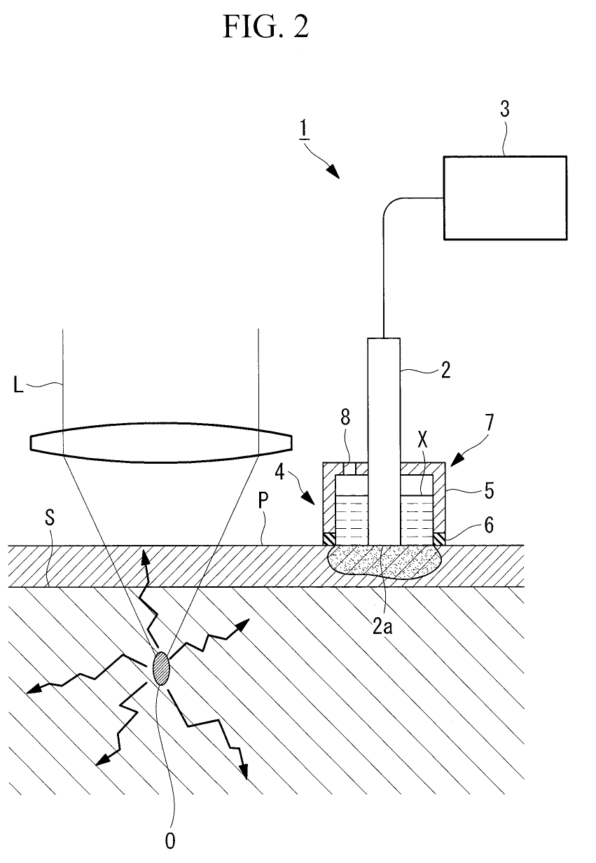

As shown in FIG. 2, the scatter suppressing unit 4 includes a cylindrical outer wall section (tubular section) 5 that is fixed to the optical fiber probe 2 and that is disposed away from the input end 2a of the optical fiber probe 2 in the radially outer direction so as to surround the input end 2a, and also includes a seal member (chemical-solution retainer, sealing part) 6 that is provided at one end of the outer wall section 5 and that seals the gap between one end of the outer wall section 5 and the outer surface of biological tissue P in a liquid-tight state at the radially outer side of the input end 2a when the input end 2a of the optical fiber probe 2 is brought close to the outer surface of the biological tissue P.

With the seal member 6 sealing the gap between one end of the outer wall section 5 and the outer surface of the biological tissue P, a container 7 having a bottom surface defined by the outer surface of the biological tissue P is formed, so that a chemical solution X can be retained in the container 7. In the drawings, reference sign 8 denotes an opening used for supplying the chemical solution X into the container 7 formed by the outer wall section 5.

The chemical solution X is a water-soluble liquid having a high refractive index and is, for example, an aqueous solution, such as glycerol, glucose, or DMSO.

The seal member 6 is, for example, a gasket composed of silicone rubber.

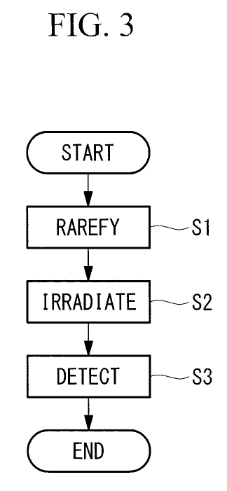

The biological tissue observation method using the biological tissue observation apparatus 1 according to this embodiment having the above-described configuration will be described below with reference to FIG. 3.

The biological tissue observation method according to this embodiment involves bringing the input end 2a disposed at one end of the optical fiber probe 2 of the biological tissue observation apparatus 1 and the outer wall section 5 of the scatter suppressing unit 4 fixed near the input end 2a close to the outer surface of the biological tissue P that covers an observation site S to be observed.

Thus, the input end 2a of the optical fiber probe 2 is brought close to or into contact with the outer surface of the biological tissue P, the outer wall section 5 is disposed so as to surround the adjoining or contact position of the input end 2a, and the gasket 6 is compressed between one end of the outer wall section 5 and the outer surface of the biological tissue P, whereby the gap between the outer wall section 5 and the biological tissue P is sealed. Consequently, this forms the container 7 having a sidewall defined by the outer wall section 5 and a bottom surface defined by the outer surface of the biological tissue P surrounded by the outer wall section 5, so that the chemical solution X can be supplied into the container 7 via the opening 8.

When the chemical solution X is supplied into the container 7 having a sidewall defined by the outer wall section 5, the chemical solution X is retained in the container 7 so that the outer surface of the biological tissue P serving as the bottom surface of the container 7 is brought into contact with the chemical solution X in an immersed state. Then, the chemical solution X is maintained in contact with the outer surface of the biological tissue P for a predetermined period of time (rarefying step S1). Thus, through the outer surface of the biological tissue P, the chemical solution X penetrates the biological tissue P over a relatively large region near the input end 2a and centered on the adjoining or contact position of the input end 2a of the optical fiber probe 2, so that the biological tissue P is denatured and the refractive-index distribution therein is made uniform.

In this state, excitation light L is radiated from outside the biological tissue P onto the observation site S therein (irradiating step S2).

The excitation light L may be radiated via the biological tissue P in the region where the refractive-index distribution is made uniform by the penetration of the chemical solution X, or the excitation light L may have a relatively high intensity such that the radiated excitation light L can pass through the biological tissue P and reach the observation site S therein in an area where the chemical solution X has not penetrated.

When the excitation light L is radiated onto the observation site S in the irradiating step S2, a fluorescent material O existing inside the observation site S is excited so that fluorescence is generated. A portion of the generated fluorescence is transmitted through an area rarefied in the rarefying step S1, which is included in the biological tissue P covering the observation site S, from the observation site S so as to be output outward from the outer surface of the biological tissue P. Because the input end 2a of the optical fiber probe 2 is disposed close to or in contact with the outer surface of the biological tissue P, the fluorescence transmitted through the biological tissue P from the observation site S and output outward from the outer surface is input to the input end 2a of the optical fiber probe 2 and is detected by the photodetector 3 connected to the base end of the optical fiber probe 2 (detecting step S3).

Then, while moving the irradiation position of the excitation light L in the irradiating step S2, the fluorescence detection in the detecting step is repeated at each irradiation position, so that a two-dimensional or three-dimensional fluorescence image of the observation site S can be acquired.

Accordingly, in the biological tissue observation apparatus 1 and the biological tissue observation method according to this embodiment, fluorescence is detected in a state where the refractive-index distribution is made uniform by using the chemical solution X to denature at least the biological tissue P near the position where the input end 2a of the optical fiber probe 2 is disposed, so that the fluorescence is efficiently captured while scattering of the fluorescence in the biological tissue P is suppressed. This is advantageous in that a clear fluorescence image of the observation site S can be acquired.

In this case, the fluorescence image of the observation site S covered by the biological tissue P can be acquired without resecting the biological tissue P. This is advantageous in that invasiveness to the biological tissue is avoided so that the load on the biological tissue can be significantly reduced.

Furthermore, for example, in a case where the observation site S is brain tissue and the biological tissue P covering the observation site S is the cranium, it is not necessary to resect the cranium, which is sometimes difficult to surgically resect, thereby simplifying the surgical procedure. Moreover, since an opening is not to be formed in the cranium, the physiological state, such as the brain pressure, does not have to be changed, whereby an advantage is afforded in that the biological tissue can be observed in vivo in a normal physiological state.

In this embodiment, the seal member 6 formed of a gasket provided at one end of the outer wall section 5 is used to seal the chemical solution X to prevent it from leaking outside the outer wall. Alternatively, the outer wall section 5 may be adhered in a sealed state to the outer surface of the biological tissue P by means of an adhesive.

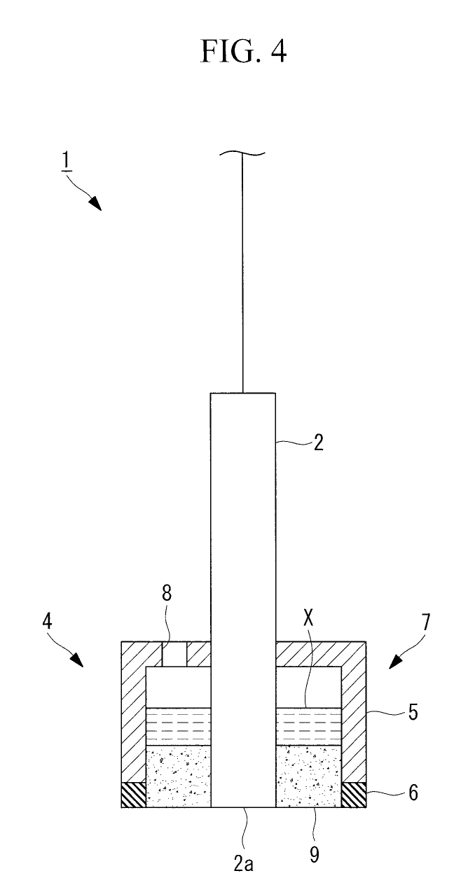

Furthermore, as shown in FIG. 4, a sponge (porous member) 9 may be disposed to fill the annular space between the outer wall section 5 and the optical fiber probe 2 such that, when bringing the input end 2a of the optical fiber probe 2 close to or into contact with the biological tissue P, the sponge 9 comes into contact with the outer surface of the biological tissue P. Accordingly, the chemical solution X supplied into the outer wall section 5 is impregnated in the sponge 9 so as to be retained in the sponge 9. Then, when the sponge 9 comes into contact with the outer surface of the biological tissue P, the chemical solution X impregnated in the sponge 9 is squeezed out therefrom and penetrates the biological tissue P through the outer surface thereof.

Furthermore, the present invention is not limited to a fluorescence observation apparatus and a fluorescence observation method and may be applied to any other optical biological tissue observation apparatus and optical biological tissue observation method, such as bright-field observation.

As a result, the above-described embodiment leads to the following aspects.

An aspect of the present invention provides a biological tissue observation apparatus including a photodetector that detects light and a scatter suppressing unit that is provided in the photodetector and that denatures biological tissue disposed facing the photodetector so as to make a refractive-index distribution in the biological tissue uniform.

According to this aspect, the photodetector is disposed facing the outer surface of the biological tissue that covers the observation site, and the scatter suppressing unit provided in the photodetector is activated so as to denature the biological tissue disposed facing the photodetector, thereby causing the light from the observation site to be transmitted through the biological tissue, the refractive-index distribution of which has been made uniform, and be detected by the photodetector. By making the refractive-index distribution in the biological tissue that covers the observation site uniform, scattering of the light from the biological tissue is suppressed, so that the photodetector can detect the light more efficiently.

Specifically, when optically observing an observation site covered by biological tissue having strong light scattering properties, scattering is suppressed by rarefying the biological tissue, so that the biological tissue can be observed without being resected. Consequently, the biological tissue can be easily observed in vivo in a normal physiological state while reducing the load on the biological tissue.

In the above aspect, the scatter suppressing unit may include a tubular section that is disposed at a position surrounding the photodetector and that retains therein a chemical solution that penetrates and denatures the biological tissue, and may also include a chemical-solution retainer that retains the chemical solution within the tubular section while causing the chemical solution to penetrate the biological tissue disposed facing the photodetector.

Accordingly, one end of the tubular section is brought close to the outer surface of the biological tissue so as to cause the chemical solution retained within the tubular section by the chemical-solution retainer to penetrate the biological tissue. Thus, the biological tissue disposed facing the photodetector is easily rarefied so that scattering of the light is suppressed, whereby the observation site disposed deep in the biological tissue can be optically observed without resecting the biological tissue.

Furthermore, in the above aspect, the chemical-solution retainer may be a sealing part that causes one end of the tubular section to be in contact with a surface of the biological tissue in a liquid-tight state.

Accordingly, one end of the tubular section is brought into contact with the outer surface of the biological tissue so that the chemical solution retained within the tubular section is prevented from leaking outward from the tubular section. Thus, the chemical solution can be kept in contact with the biological tissue disposed facing the photodetector, thereby facilitating the penetration of the chemical solution into the biological tissue.

Furthermore, in the above aspect, the chemical-solution retainer may be a porous member that is disposed to close an annular space between the tubular section and the photodetector and that is to be impregnated with the chemical solution.

Accordingly, the chemical solution retained in the tubular section is impregnated in the porous member. Thus, the chemical solution is prevented from leaking outward from the tubular section by the chemical-solution retainer formed of the porous member, so that the chemical solution can be kept in contact with the biological tissue that is in contact with the porous member, thereby facilitating the penetration of the chemical solution into the biological tissue.

Furthermore, another aspect of the present invention provides a biological tissue observation method including a rarefying step of denaturing biological tissue covering an observation site so as to make a refractive-index distribution in the biological tissue uniform and a detecting step of detecting light released outward from the observation site via the biological tissue denatured in the rarefying step.

In the above aspect, the biological tissue observation method may further include an irradiating step of radiating excitation light onto the observation site. The detecting step may include detecting fluorescence that is generated in the observation site as a result of the observation site being irradiated with the excitation light in the irradiating step and that is released outward via the biological tissue denatured in the rarefying step.

Furthermore, in the above aspect, the rarefying step may include causing a chemical solution, which denatures the biological tissue so as to make the refractive-index distribution therein uniform, to penetrate the biological tissue.

The present invention is advantageous in that a biological tissue can be easily observed in vivo in a normal physiological state while reducing the load on the biological tissue.

### REFERENCE SIGNS LIST

1 biological tissue observation apparatus
3 photodetector
4 scatter suppressing unit
5 outer wall section (tubular section)
6 seal member (chemical-solution retainer, sealing part)
L excitation light
P biological tissue
S observation site
X chemical solution

1. A biological tissue observation apparatus comprising:
a photodetector that detects light; and
a scatter suppressing unit that denatures biological tissue disposed facing the photodetector so as to make a refractive-index distribution in the biological tissue uniform.

2. The biological tissue observation apparatus according to claim 1,
wherein the scatter suppressing unit includes
a tubular section that is disposed at a position surrounding the photodetector and that retains therein a chemical solution that penetrates and denatures the biological tissue, and
a chemical-solution retainer that retains the chemical solution within the tubular section while causing the chemical solution to penetrate the biological tissue disposed facing the photodetector.

3. The biological tissue observation apparatus according to claim 2,
wherein the chemical-solution retainer is a sealing part that causes one end of the tubular section to be in contact with a surface of the biological tissue in a liquid-tight state.

4. The biological tissue observation apparatus according to claim 2,
wherein the chemical-solution retainer is a porous member that is disposed to close an annular space between the tubular section and the photodetector and that is to be impregnated with the chemical solution.

5. A biological tissue observation method comprising:
a rarefying step of denaturing biological tissue covering an observation site so as to make a refractive-index distribution in the biological tissue uniform; and
a detecting step of detecting light released outward from the observation site via the biological tissue denatured in the rarefying step.

6. The biological tissue observation method according to claim 5, further comprising:
an irradiating step of radiating excitation light onto the observation site,
wherein the detecting step includes detecting fluorescence that is generated in the observation site as a result of the observation site being irradiated with the excitation light in the irradiating step and that is released outward via the biological tissue denatured in the rarefying step.

7. The biological tissue observation method according to claim 5,
wherein the rarefying step includes causing a chemical solution, which denatures the biological tissue so as to make the refractive-index distribution therein uniform, to penetrate the biological tissue.
